(19) United States
(12) Patent Application Publication
(10) Pub. No.: US 2025/0077282 A1
(43) Pub. Date: Mar. 6, 2025

(54) DIGITAL COMPUTE-IN-MEMORY SYSTEM WITH WEIGHT LOCALITY HAVING HIGHER ROW DIMENSION AND ASSOCIATED METHOD

(71) Applicant: MEDIATEK INC., Hsin-Chu (TW)

(72) Inventors: Ming-Hung Lin, Hsinchu City (TW); Ming-En Shih, Hsinchu City (TW); Shih-Wei Hsieh, Hsinchu City (TW); Ping-Yuan Tsai, Hsinchu City (TW); You-Yu Nian, Hsinchu City (TW); Pei-Kuei Tsung, Hsinchu City (TW); Jen-Wei Liang, Hsinchu City (TW); Shu-Hsin Chang, Hsinchu City (TW); En-Jui Chang, Hsinchu City (TW); Chih-Wei Chen, Hsinchu City (TW); Po-Hua Huang, Hsinchu City (TW); Chung-Lun Huang, Hsinchu City (TW)

(73) Assignee: MEDIATEK INC., Hsin-Chu (TW)

(21) Appl. No.: 18/820,342

(22) Filed: Aug. 30, 2024

Related U.S. Application Data
(60) Provisional application No. 63/536,081, filed on Sep. 1, 2023.

(51) Int. Cl. G06F 9/50; G06F 17/15

(52) U.S. Cl. CPC G06F 9/5016; G06F 17/15

(57) ABSTRACT

A digital compute-in-memory (DCIM) system includes a first DCIM macro. The first DCIM macro includes a first memory cell array and a first arithmetic logic unit (ALU). The first memory cell array has N rows that are configured to store weight data of a neural network in a single weight data download session, wherein N is a positive integer not smaller than two. The first ALU is configured to receive a first activation input, and perform convolution operations upon the first activation input and a single row of weight data selected from the N rows of the first memory cell array to generate first convolution outputs.

### CROSS REFERENCE TO RELATED APPLICATIONS

This application claims the benefit of U.S. Provisional Application No. 63/536,081, filed on Sep. 1, 2023. The content of the application is incorporated herein by reference.

### BACKGROUND

The present invention relates to a compute-in-memory (CIM) design, and more particularly, to a digital compute-in-memory (DCIM) system with weight locality having a higher row dimension and an associated method.

Machine learning (or deep learning) is the ability of a computing device to progressively improve performance of a particular task. For example, machine learning algorithms can use results from processing known data to train a computing device to process new data with a higher degree of accuracy. Neural networks are a framework in which machine learning algorithms may be implemented. A neural network is modeled with a plurality of nodes. Each node receives input signals from preceding nodes and generates an output that becomes an input signal to succeeding nodes. The nodes are organized in sequential layers such that, in a first processing stage, nodes of a first layer receive input data from an external source and generate an output that is provided to every node in a second layer. In a next processing stage, nodes of the second layer receive the outputs of each node in the first layer, and generate further outputs to be provided to every node in a third layer as the nodes in the first layer receive and process new external inputs, and so on in subsequent processing stages. Within each node, each input signal is uniquely weighted by multiplying the input signal by an associated weight. The products corresponding to the weighted input signals are summed to generate a node output. These operations performed at each node are known as a multiply-accumulate (MAC) operation. Digital compute-in-memory (DCIM) has advantages of performing robust and efficient MAC operations, compared to analog CIM solutions.

With the rise in device resolution and the push for better user experience, there's a growing need for sustainable visual-quality improvement on edge devices. Machine learning (or deep learning) algorithms have made impressive progress in pixel-level processing tasks such as super-resolution and noise reduction. However, the deployment of these algorithms in real-time, high-resolution scenarios on edge devices is challenging due to constraints in memory bandwidth, power, and area. Thus, there is a need for an innovative DCIM-based neural engine for sustainable visual-quality enhancement on edge devices.

### SUMMARY

One of the objectives of the claimed invention is to provide a DCIM system with weight locality having a higher row dimension and an associated method.

According to a first aspect of the present invention, an exemplary DCIM system is disclosed. The digital DCIM includes a first DCIM macro. The first DCIM macro includes a first memory cell array and a first arithmetic logic unit (ALU). The first memory cell array has N rows that are configured to store weight data of a neural network in a single weight data download session, wherein N is a positive integer not smaller than two. The first ALU is configured to receive a first activation input, and perform convolution operations upon the first activation input and a single row of weight data selected from the N rows of the first memory cell array to generate first convolution outputs.

According to a second aspect of the present invention, an exemplary DCIM method is disclosed. The exemplary DCIM method includes: storing weight data corresponding to a neural network into N rows of a first memory cell array included in a first DCIM macro, wherein N is a positive integer not smaller than two; and performing convolution operations upon a first activation input of the first DCIM macro and a single row of weight data selected from the N rows of the first memory cell array to generate first convolution outputs.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a DCIM system according to an embodiment of the present invention.

FIG. 2 is a diagram illustrating a 4-cycle row switching data flow according to an embodiment of the present invention.

FIG. 3 is a diagram illustrating a hardware engine fusion design according to an embodiment of the present invention.

FIG. 4 is a diagram illustrating a fusion architecture that pipelined convolution engines to balances the workload across enhance the utilization rate and power efficiency according to an embodiment of the present invention.

FIG. 5 is a diagram illustrating different load-balanced pipeline designs for different NN models according to an embodiment of the present invention.

FIG. 6 is a diagram illustrating an example of partitioning an NN model into segments according to weight capacity of the DCIM system according to an embodiment of the present invention.

FIG. 7 is a diagram illustrating a data access pattern used for strided convolution (stride=2) according to an embodiment of the present invention.

FIG. 8 is a diagram illustrating a data access pattern used for transposed convolution (stride=2) according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

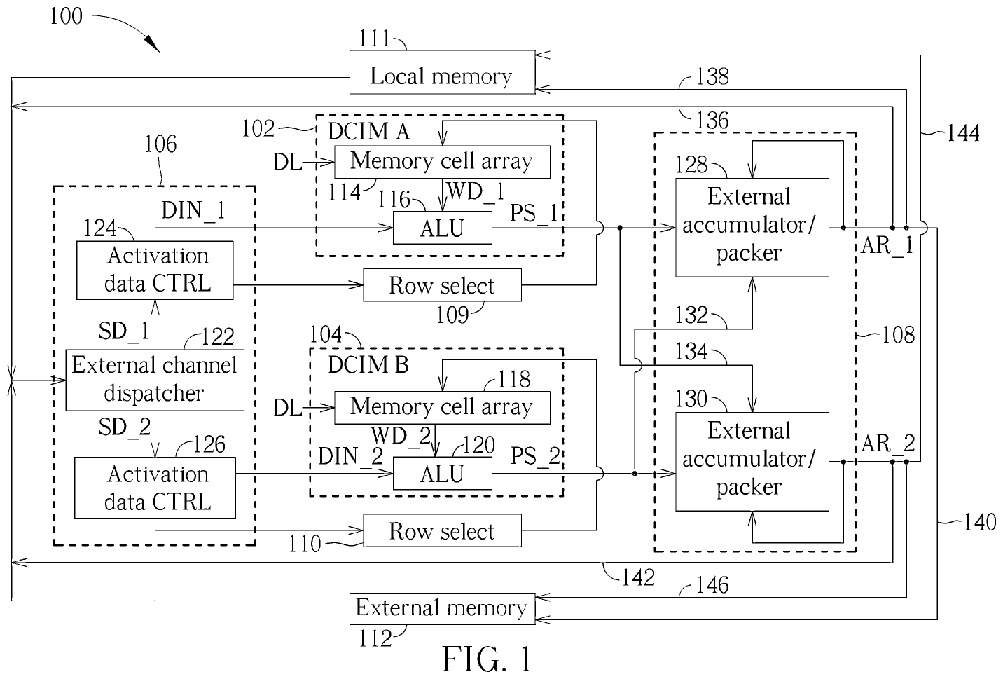

FIG. 1 is a diagram illustrating a DCIM system according to an embodiment of the present invention. The DCIM system 100 includes M DCIM macros (M≥1). In this embodiment, the DCIM system 100 is shown having multiple DCIM macros, such as DCIM macro (labeled by “DCIM A”) 102 and DCIM macro (labeled by “DCIM B”) 104. It should be noted that a DCIM system with a single DCIM macro that employs any of the proposed performance enhancement techniques also falls within the scope of the present invention. The DCIM system 100 further includes a pre-processing circuit 106, a post-processing circuit 108, a plurality of row selection circuits (labeled by “row select”) 109, 110, a local memory 111, and an external memory 112. For example, the local memory 111 may be a static random access memory (SRAM), and the external memory 112 may be a dynamic random access memory (DRAM). In practice, the present invention has no limitations on actual implementation of the local memory 111 and the external memory 112. For example, each of the local memory 111 and the external memory 112 may be replaced by any storage device with data buffering capability.

The pre-processing circuit 106 may include a plurality of circuit blocks, such as an external channel dispatcher 122 shared between DCIM macros 102, 104, an activation data controller (labeled by “activation data CTRL”) 124 dedicated to providing an activation input DIN 1 to the DCIM macro 102, and an activation data controller (labeled by “activation data CTRL”) 126 dedicated to providing an activation input DIN 2 to the DCIM macro 104. The post-processing circuit 108 may include a plurality of circuit blocks, such as one external accumulator/packer 128 coupled to both of the DCIM macros 102, 104, and another external accumulator/packer 128 also coupled to both of the DCIM macros 102, 104. In a case where the DCIM system 100 is modified to have only one DCIM macro 102, the activation data controller 126, the DCIM macro 104, and the external accumulator/packer 130 may be omitted.

Each of the DCIM macros 102 and 104 may have the same structure. As shown in FIG. 1, the DCIM macro 102 includes a memory cell array 114 and an arithmetic logic unit (ALU) 116, and the DCIM macro 104 includes a memory cell array 118 and an ALU 120. The memory cell array 114/118 may include a plurality of SRAM cells, and is configured to store weight data of a neural network (e.g., convolutional neural network (CNN)). For example, the memory cell array 114/118 may be used to store weights of one or more layers of an NN model. The ALU 116/120 is configured to perform in-memory computing (particularly, in-memory MAC operations) upon activation data and weight data. In this embodiment, the memory cell array 114/118 has N rows that are configured to store weight data of the neural network in a single weight data download session DL. N is a positive integer not smaller than two (i.e., N≥2). For example, the memory cell array 114/118 may have 18 rows (N=18). The memory cell array 114/118 may communicate with an external memory (e.g., DRAM) through a memory interface. Hence, the memory cell array 114/118 may receive weight data of the neural network from the external memory (e.g., DRAM) in the single weight data download session DL. With the use of the proposed memory cell array 114/118, the DCIM macro 102/104 supports weight locality having a higher row dimension.

The ALU 116/120 is configured to receive the activation input (which may include activation data of multiple input channels) DIN_1/DIN_2, and perform convolution operations upon the activation input DIN_1/DIN_2 and a single row of weight data WD_1/WD_2 selected from the N rows of the memory cell array 114/118 to generate convolution outputs (e.g., partial sums of multiple output channels) PS_1/PS_2. Specifically, the activation input DIN_1/DIN_2 is managed by the activation data controller 124/126, and selection/switching of the single row of weight data WD_1/WD_2 is managed by the row selection circuit 109/110 according to activation data related information provided from the activation data controller 124/126. The external accumulator/packer 128/130 is arranged to perform accumulation upon the convolution outputs (e.g., partial sums) PS_1/PS_2 to generate final convolution results of output channels.

By way of example, but not limitation, the DCIM macro 102/104 may be a 72 (3×3×8) input channel (ich)/8 output channel (och)/576 MAC @ 12 bit DCIM macro, and the memory cell array 114/118 may have 18 rows. Hence, in each cycle, the DCIM macro 102/104 computes 8 sets of 72×12-bit dot-products, where the weights are locally stored in 18 rows with a specific row selected for use by the row selection circuit 109/110. Partial sums of the same output channel can be externally accumulated to generate a final convolution result of the output channel.

During each weight data download session DL between an external memory (e.g., SRAM) and the memory cell array (e.g., SRAM cell array) 114/118, a bunch of weights can be retrieved and written into N (N≥2) rows of SRAM cells of the memory cell array 114/118 to complete one weight data update (i.e., reloading of weights). Before a next weight data download session DL (i.e., next weight data reloading) starts, the row selection circuit 109/110 may select/enable N (N≥2) rows of weight data one by one. The use of weight locality having a higher row dimension in the DCIM macro 102/104 allows for fewer weight data updates, which leads to significant time and power consumption savings. Unlike traditional approaches where weight data needs to be updated frequently, the weight locality having a higher row dimension reduces the need for frequent updates, resulting in improved efficiency and reduced resource utilization.

Before the weight data stored in the memory cell array 114/118 are updated by a next weight data download session DL, row switching control can be applied to the memory cell array 114/118 for selecting/enabling different rows sequentially. In this embodiment, the row selection circuit 109/110 is configured to select one row of weight data from the memory cell array 114/118 to act as the single row of weight data WD_1/WD_2 to undergo in-memory MAC operations at the ALU 116/120, and is further configured to update the single row of weight data WD_1/WD_2 by selecting a different row of weight data selected from the memory cell array 114/118 when the single row of weight data WD_1/WD_2 is currently set by one row of weight data.

If the row switching happens every cycle, it means that the weights need to be toggled to the MAC stage once for each cycle. Consequently, the weight toggling to the MAC stage consumes more energy since it happens more frequently. To address this issue, the present invention proposes performing the row switching every T cycles, where T≥2. If the row switching happens every T cycles, it means that the weights need to be toggled to the MAC stage once for every T cycles. In this way, the weight toggling to the MAC stage consumes less energy overall compared to switching every cycle. In some embodiments of the present invention, a data reordering scheme may be employed to achieve the T-cycle row switching operation for a low-power DCIM macro. The pre-processing circuit 106 (particularly, activation data controller 124/126) is configured to receive a source activation input SD_1/SD_2 in a first order, and output the buffered source activation input SD_1/SD_2 in a second order to generate and output the activation input DIN_1/DIN_2 to the DCIM macro 102/104, where the second order is different from the first order. For example, the activation data controller 124/126 may have a data put buffer that acts as a ping-pong buffer, and may simultaneously receive input data while dispatching reordered data, thus allowing for a longer row switching cycle and full utilization of the computation resources. In this embodiment, the first order is a channel-first order, and the second order is a pixel-first order. In accordance with the channel-first order, collocated pixels of different input channels (ich) are sequentially received by the activation data controller 124/126. In accordance with the pixel-first order, pixels of the same input channel are sequentially read and output from the activation data controller 124/126 to the DCIM macro 102/104.

When a data reordering scheme is enabled at the pre-processing circuit 106 (particularly, activation data controller 124/126), a counterpart data reordering scheme is enabled at the post-processing circuit 108 (particularly, external accumulator/packer 128/130). The convolution outputs (e.g., partial sums) PS_1/PS_2 are generated from the DCIM macro 202/204 according to the activation input DIN_1/DIN_2 in the pixel-first order. The post-processing circuit 108 (particularly, external accumulator/packer 128/130 of post-processing circuit 108) is responsible for storing, accumulating, and/or reassembling data. For example, the external accumulator/packer 128/130 may include an accumulator and a reorder buffer. Hence, the external accumulator/packer 128/130 may perform accumulation according to the convolution outputs (e.g., partial sums) PS_1/PS_2 to generate accumulation results in the second order (e.g., pixel-first order), and convert the second order (e.g., pixel-first order) back to the first order (e.g., channel-first order) for updating convolution results of different output channels according to the accumulation results.

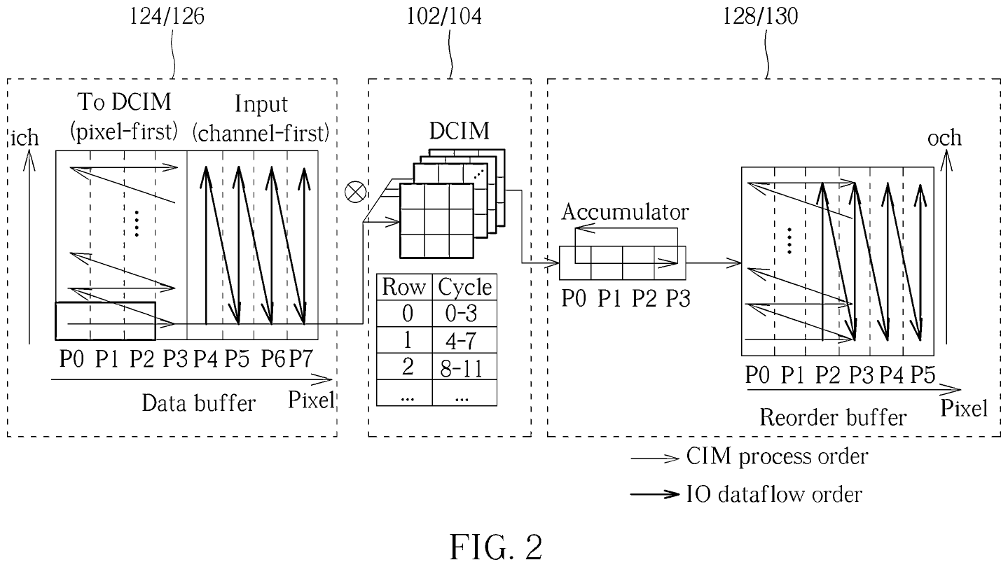

FIG. 2 is a diagram illustrating a 4-cycle row switching data flow according to an embodiment of the present invention. With proper data reordering, a low-power DCIM macro with a 4-cycle row switching operation can be realized. A factor impacting DCIM efficiency is the frequency of row switching, which occurs when alternating to compute a different set of channels. Extending the row switching cycle can enhance power efficiency. However, this also requires more pixels to be stored in the input and output buffers, leading to a larger area overhead. As the row switching cycle increases, it is observed that an initial boost in power efficiency eventually reaches plateaus, alongside a linear increase in the total system area due to higher buffer requirements. To achieve the best power-to-area tradeoff, a 4-cycle row switching may be selected to maximize the energy efficiency to area ratio. However, this is for illustrative purposes only, and is not meant to be a limitation of the present invention. Any DCIM macro that uses the proposed T-cycle row switching scheme (T≥2) falls within the scope of the present invention.

The row selection circuit 109/110 does not need to do row switching frequently. In some embodiments of the present invention, the row switching cycle T may be adaptively adjusted. For example, the frequency of row switching may be optimized based on the specific requirements of the NN model and the convolution operation being performed. By dynamically controlling the row switching frequency, power consumption can be effectively reduced, making the hardware architecture more efficient and resource-conscious.

In some embodiments of the present invention, the row selection circuit 109/110 and the external accumulator/packer 128/130 can enable the DCIM macro 102/104 to act as a flexible DCIM macro which is capable of supporting different combinations of input channels and output channels (ich, och) for convolutions. This enables various configurations to be easily implemented, allowing for greater customization and adaptation in handling different convolution operations. The inclusion of the external accumulator/packer 128/130 adds another layer of flexibility and adaptability to the hardware architecture. Specifically, the external accumulator/packer 128/130 facilitates the dynamic combination of convolution's input channels and output channels, allowing for customizable configurations. This flexibility enables the hardware architecture to handle a wide range of input channel and output channel combinations efficiently.

In this embodiment, the DCIM system 100 can efficiently handle different cases and scenarios, providing better scalability and versatility. For example, the external accumulator/packer 128/130 may be equipped with an accumulation function and a packing function. The external accumulator/packer 128/130 may accumulate multiple convolution outputs each corresponding to a first input channel number, to generate an accumulation result that corresponds to a second input channel number larger than the first input channel number. The external accumulator/packer 128/130 may pack multiple convolution outputs each corresponding to a first output channel number, to generate a packing result that corresponds to a second output channel number larger than the first output channel number.

By way of example, but not limitation, the DCIM macro 102/104 may be a 72 (3×3×8) ich/8 och/576 MAC @ 12 bit DCIM macro, the memory cell array 114/118 may have 24 rows, and an NN model may have layers with filter sizes of 3×3 and higher dimensions of ich/och at 8/192, 192/8, 16/96, and 96/16, respectively. For the 8/192 layer, the row selection circuit 109/110 will select rows 1 to 24 in order. Meanwhile, the external accumulator/packer 128/130 will pack the result of each DCIM macro's 8 och sequentially. Finally, the output will consist of 24 sets of 8 och, totaling 192 och. For the 192/8 layer, the row selection circuit 109/110 will select rows 1 to 24 in order. The external accumulator/packer 128/130 will accumulate the result of each DCIM macro's 8 och sequentially. Finally, the external accumulator/packer 128/130 will output the result of 8 och. For the 16/96 layer, the row selection circuit 109/110 will select rows 1 to 24 in order. The external accumulator/packer 128/130 will accumulate the result of each DCIM macro's 8 och twice, sequentially pack the results, and finally output 12 sets of 8 och, totaling 96 och. For the 96/16 layer, the row selection circuit 109/110 will select rows 1 to 24 in order. The external accumulator/packer 128/130 will accumulate the result of each DCIM macro's 8 och 12 times, sequentially pack the results, and finally output 2 sets of 8 och to create 16 och as the output.

In some embodiments of the present invention, multiple DCIM macros (e.g., two DCIM macros 102 and 104 in this embodiment) can be combined to act as a large DCIM macro with higher computing power to support an ultra-high-dimensional NN model. This capability significantly reduces the area cost and power consumption, for example, by using just two DCIM macros 102 and 104. For example, the pre-processing circuit 106 (particularly, external channel dispatcher 122 of pre-processing circuit 106) is configured to generate and output two source activation inputs SD_1 and SD_2 by splitting input channels, where the source activation input SD_1 corresponds to a first part of the input channels (e.g., one half of input channels), the source activation input SD_2 corresponds to a second part of the input channels (e.g., the other half of input channels), the activation input SIN_1 is derived from the source activation input SD_1, and the activation input DIN_2 is derived from the source activation input SD_2; and the convolution outputs (e.g., partial sums) PS_1 and PS_2 are accumulated and then combined at the post-processing circuit 108 (particularly, external accumulator/packer 128 (or 130) of post-processing circuit 108) to generate final convolution results of different output channels. Specifically, the external accumulator/packer 128 can obtain the convolution outputs (e.g., partial sums) PS_2 of the DCIM macro 104 through a data path 132, and the external accumulator/packer 130 can obtain the convolution outputs (e.g., partial sums) PS_1 of the DCIM macro 102 through a data path 134.

By way of example, but not limitation, the DCIM macro 102/104 may be a 72 (3×3×8) ich/8 och/576 MAC @ 12 bit DCIM macro, the memory cell array 114/118 may have 24 rows, and an NN model may have layers with filter sizes of 3×3, including one layer with dimensions of ich/och at 384/8. For the 384/8 layer, the external channel dispatcher 122 evenly splits 384-channel activation input into two 192-channel activation inputs that are provided to two DCIM macros 102 and 104, respectively. That is, the activation input DIN_1 is one 192-channel activation input, and the activation input DIN_2 is the other 192-channel activation input. Each of the row selection circuits 109 and 110 will select rows 1 to 24 sequentially. The DCIM macros 102 and 104 exchange convolution outputs (e.g., partial sums) PS_1, PS_2 through data paths 132, 134. The external accumulator/packer 128 (or 130) will accumulate and combine the result of each DCIM macro's 8 och, sequentially. Finally, the external accumulator/packer 128 (or 130) will output the convolution result of 8 och.

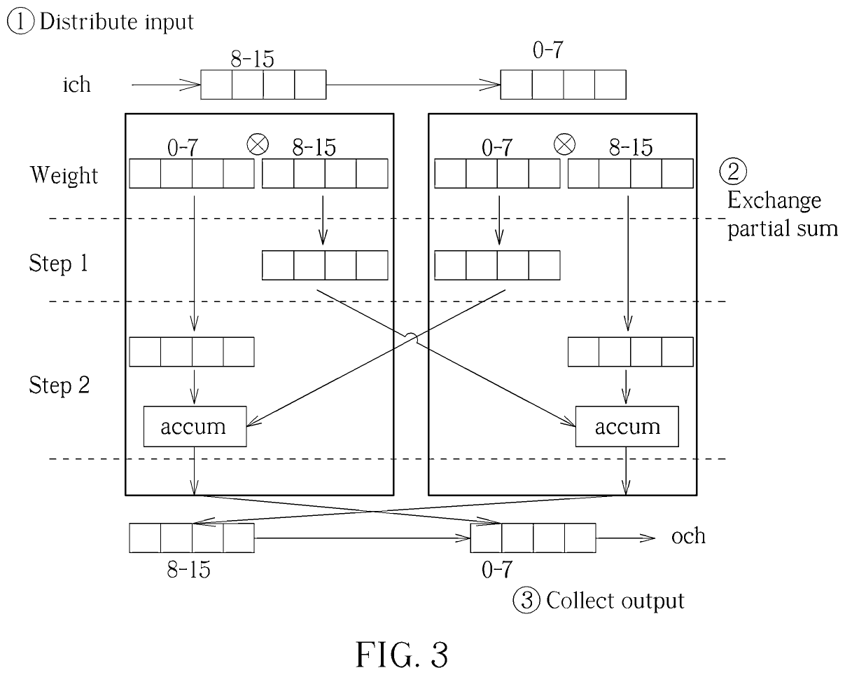

The operation of a large DCIM macro resulting from combining multiple DCIM macros (e.g., only two DCIM macros 102 and 104) may include an input distribution phase (which is performed via external channel dispatcher 122), a partial sum exchange phase (which is performed via data path 132/134), and an output collection phase (which is performed via external accumulator/packer 128/130). FIG. 3 is a diagram illustrating a hardware engine fusion design according to an embodiment of the present invention. The convolution workload is evenly divided between two DCIM macros. Each DCIM macro processes a half of the input channels. The DCIM macros perform simultaneous convolutions, and then exchange partial sums for accumulation, each ending up with half of the final output channels. These results are combined to generate a complete output of the convolution operation. It should be noted that the same concept can also apply to a large DCIM macro resulting from combining more than two DCIM macros. This approach of combining multiple DCIM macros to act as a larger DCIM macro enables the DCIM system to seamlessly integrate into the entire NN model and efficiently handle the computations required for different layer configurations.

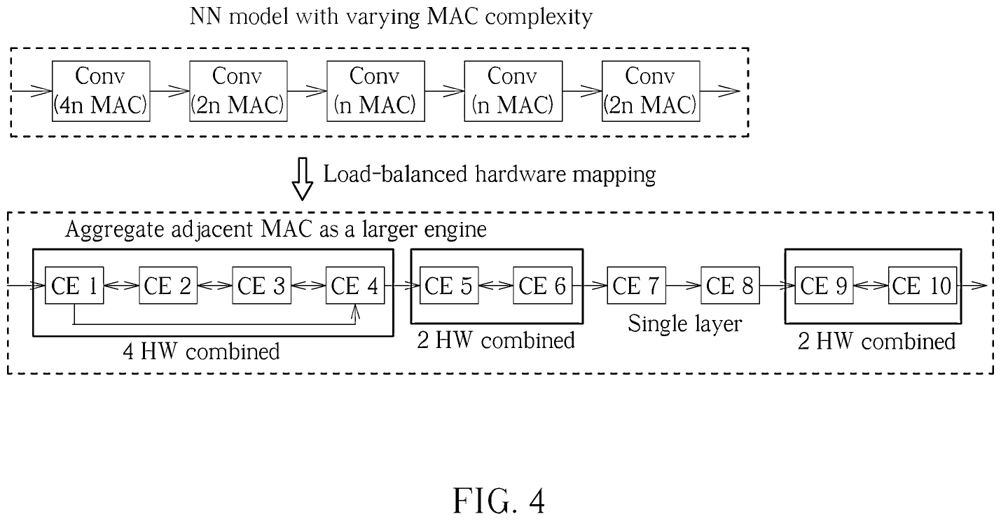

FIG. 4 is a diagram illustrating a fusion architecture that balances the workload across pipelined convolution engines (CEs) to enhance the utilization rate and power efficiency according to an embodiment of the present invention. Each of the CEs includes one DCIM macro. The concurrent execution of different pipeline stages enables direct communication along the pipeline, eliminating the need for memory access and reducing on-chip memory usage. As shown in FIG. 4, the execution of the entire NN model can be completed using the DCIM system with balancing of the workload across different stages of the pipeline. As mentioned above, multiple DCIM macros can be combined to act as a larger DCIM macro with higher computing power. In this embodiment, the proposed engine fusion technique groups nearby computational resources (i.e., CEs), which prevents any single stage from becoming a bottleneck and thus improves the overall system utilization. To complete the execution of the NN model with varying MAC complexity, four CEs (labeled by “CE 1”, “CE 2”, “CE 3”, and “CE 4”) are combined to act as a large DCIM macro for dealing with one convolution operation with MAC complexity=4n, two CEs (labeled by “CE 5” and “CE6”) are combined to act as a large DCIM macro for dealing with one convolution operation with MAC complexity=2n, a single CE (labeled by “CE 7”) is used to deal with one convolution operation with MAC complexity=n, a single CE (labeled by “CE 8”) is used to deal with one convolution operation with MAC complexity=n, and two CEs (labeled by “CE 9” and “CE 10”) are combined to act as a large DCIM macro for dealing with one convolution operation with MAC complexity=2n.

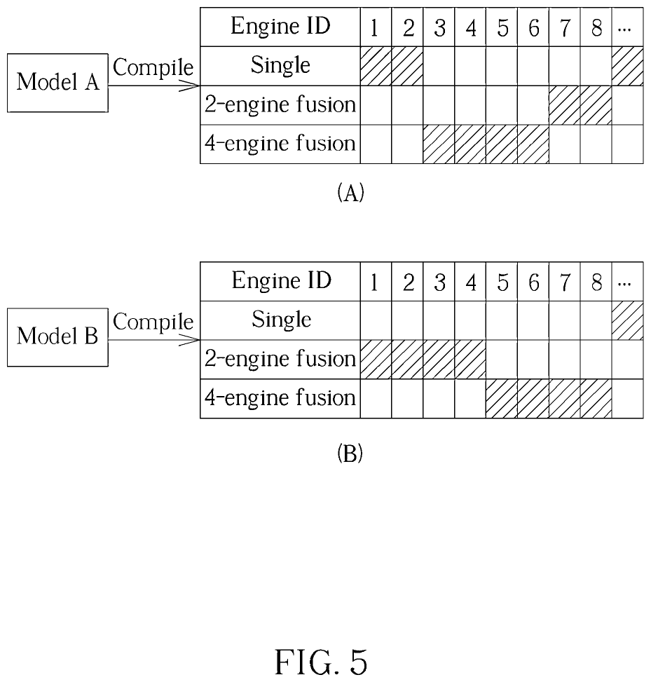

In some embodiments of the present invention, the fusion level, either 2-engine or 4-engine, can be compiler-configured per engine for optimal utilization. FIG. 5 is a diagram illustrating different load-balanced pipeline designs for different NN models according to an embodiment of the present invention. The load-balanced pipeline design established by the proposed engine fusion technique can best fit the target NN model, which results in decreased memory access and power consumption.

In some embodiments of the present invention, the DCIM system 100 may be reused during execution of the NN model. Hence, the post-processing circuit 108 is configured to accumulate convolution outputs (e.g., partial sums) PS_1/PS_2 of the DCIM macro 102/104 to generate accumulation results of different output channels (e.g., 8 och) AR_1/AR_2, and the pre-processing circuit 106 is configured to retrieve the accumulation results AR_1/AR_2, and generate the next activation input DIN_1/DIN_2 to the DCIM macro 102/104 according to the loop-back accumulation results AR_1/AR_2. For example, the pre-processing circuit 106 may obtain the accumulation results AR_1/AR_2 through the data path 136/142. For another example, the post-processing circuit 108 may store the accumulation results AR_1/AR_2 into the local memory 111 through the data path 138/144, and the pre-processing circuit 106 may obtain the accumulation results AR_1/AR_2 from the local memory 111. In still another example, the post-processing circuit 108 may store the accumulation results AR_1/AR_2 into the external memory 112 through the data path 140/146, and the pre-processing circuit 106 may obtain the accumulation results AR_1/AR_2 from the external memory 112. As mentioned above, the memory cell array 114/118 has N (N≥2) rows that are configured to store weight data of the neural network in a single weight data download session DL. Hence, the DCIM system 100 has limited weight capacity compared to the entire NN model. To address this issue encountered by reusing the DCIM system 100 to complete execution of the NN model, the present invention proposes using an offline compiler to partition the NN model into segments according to the weight capacity of the DCIM system 100. This segmentation enables the DCIM system 100 to process a subset of the NN model at a time. In other words, the aforementioned loop-back accumulation results AR_1/AR_2 are final convolution results of a subset of the NN model. By efficiently managing the weight capability and leveraging the segmentation approach, the hardware architecture avoids the need for a lot of DCIM macros, making it a more resource-efficient solution.

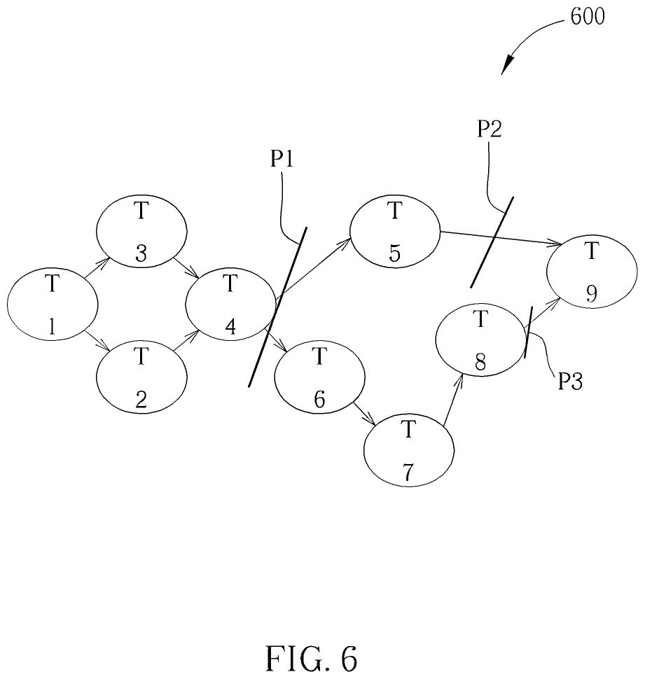

FIG. 6 is a diagram illustrating an example of partitioning an NN model into segments according to weight capacity of the DCIM system 100 according to an embodiment of the present invention. The NN model 600 has a plurality of layers T1, T2, T3, T4, T5, T6, T7, T8, T9, and is partitioned at several segmentation points P1, P2, P3. The external memory 112 may act as a feature map (FM) memory. The input of the NN model 600 may be received by the pre-processing circuit 106 (particularly, external channel dispatcher 122 of pre-processing circuit 106) from the external memory 112, while the output of the post-processing circuit 108 (particularly, external accumulator/packer 128/130 of post-processing circuit 108) may be stored in the external memory 112 for data reuse. The proposed approach involves loading the weight data of T1 to T4 layers into the DCIM system 100 (particularly, memory cell array 114/118 of DCIM macro 102/104). The pre-processing circuit 106 (particularly, external channel dispatcher 122 of pre-processing circuit 106) receives the input activation of the T1 layer from the external memory 112, and the post-processing circuit 108 (particularly, external accumulator/packer 128/130 of post-processing circuit 108) outputs the result of the T4 layer to the external memory 112. Next, the weight data of T6 to T8 layers is loaded d into the DCIM system 100 (particularly, memory cell array 114/118 of DCIM macro 102/104). The pre-processing circuit 106 (particularly, external channel dispatcher 122 of pre-processing circuit 106) receives the input activation of the T4 layer from the external memory 112, and the post-processing circuit 108 (particularly, external accumulator/packer 128/130 of post-processing circuit 108) outputs the result of the T8 layer to external memory 112. Then, the weight data of the T5 layer is loaded into the DCIM system 100 (particularly, memory cell array 114/118 of DCIM macro 102/104). The pre-processing circuit 106 (particularly, external channel dispatcher 122 of pre-processing circuit 106) receives the input activation of the T5 layer from the external memory 112, and the post-processing circuit 108 (particularly, external accumulator/packer 128/130 of post-processing circuit 108) outputs the result of the T5 layer to external memory 112. Finally, the weight data of the T9 layer is loaded into the DCIM system 100 (particularly, memory cell array 114/118 of DCIM macro 102/104). The pre-processing circuit 106 (particularly, external channel dispatcher 122 of pre-processing circuit 106) receives the results of T5 layer and T8 layer from the external memory 112, and the post-processing circuit 108 (particularly, external accumulator/packer 128/130 of post-processing circuit 108) outputs the result of the T9 layer (i.e., a final computation result of the NN model 600) to external memory 112.

In addition to normal convolution (stride=1), strided convolution (stride≥2) and transposed convolution are common in NN models. The baseline control masks unused pixels in strided convolution and inserts zeros in transposed convolution, yielding a 25% utilization rate. This would be quite wasteful in terms of power consumption. To address this issue, the present invention proposes an adaptive data control scheme that refers to a convolution type (e.g., normal convolution, strided convolution, or transposed convolution) to adaptively adjust a data access pattern for improved utilization. For the example, pre-processing circuit 106 (particularly, activation data controller 124/126) is configured to receive a source activation input SD_1/SD_2 (which may be sourced from the external memory 122 that acts as a feature map memory), determine a data access pattern according to a convolution type of convolution operations, and obtain and output the activation input DIN_1/DIN_2 from the source activation input SD_1/SD_2 by accessing (traversing) the source activation input SD_1/SD_2 according to the data access pattern. In accordance with the adaptive data control scheme, different data access patterns are selected for different convolution types. For example, the data access pattern used for strided convolution or transposed convolution is different from a data access pattern used for normal convolution.

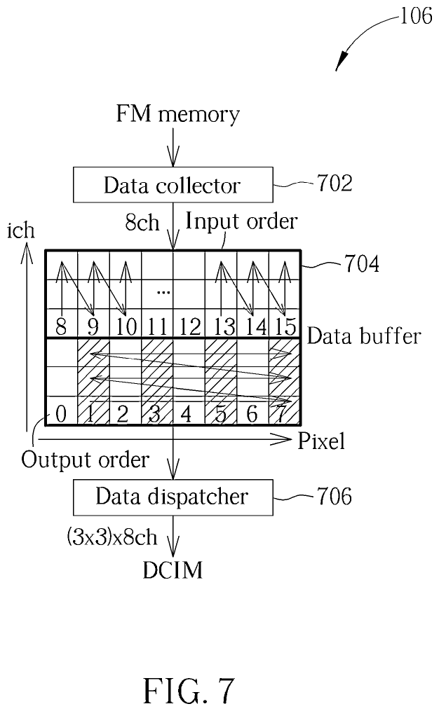

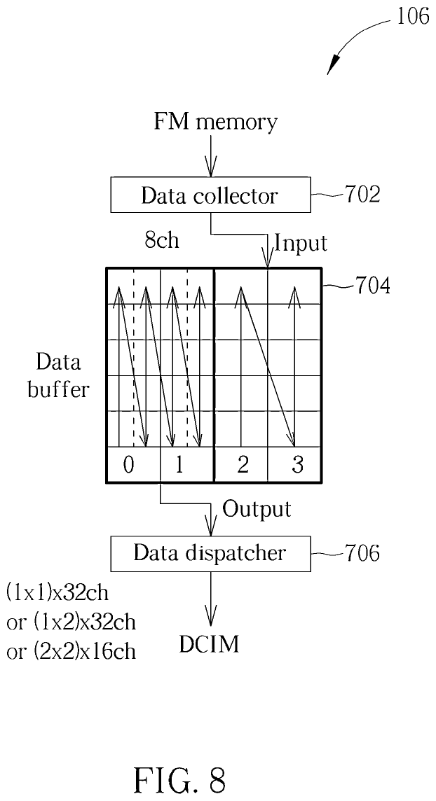

FIG. 7 is a diagram illustrating a data access pattern used for strided convolution (stride=2) according to an embodiment of the present invention. The activation data controller 124/126 may include a data collector 702, a data memory 704, and a data dispatcher 706. Regarding strided convolution (stride=2), the data dispatcher 706 traverses only the used pixels. The DCIM macro 102/104 takes advantage of the additional time to calculate more output channels while the data collector 702 is preparing the next set of pixels. In this way, the DCIM idle time can be reduced. FIG. 8 is a diagram illustrating a data access pattern used for transposed convolution (stride=2) according to an embodiment of the present invention. Regarding transpose convolution (stride=2), the data dispatcher 704 increases the percentage of effective data sent to DCIM macro 102/104 by merging input channels to improve utilization. Compared to the baseline method, the adaptive data control scheme can increase the average utilization rate from 25% to 58% and 65% for strided and transpose convolution, respectively.

The adaptive data control scheme used for utilization improvement works with the row switching control scheme used for power reduction. More specifically, the inclusion of the row selection circuit 109/110 offers flexibility and control over various convolution operations (e.g., normal convolution, strided convolution, and transposed convolution). This flexibility allows for customized combinations of row switching patterns, providing better utilization rate for the DCIM macro. By adapting the row switching control to the specific convolution operation being performed, the hardware architecture can optimize the utilization of the DCIM macro and improve overall efficiency.

Those skilled in the art will readily observe that numerous modifications and alterations of the device and method may be made while retaining the teachings of the invention. Accordingly, the above disclosure should be construed as limited only by the metes and bounds of the appended claims

What is claimed is:

1. A digital compute-in-memory (DCIM) system comprising:
a first DCIM macro, comprising:
a first memory cell array, having N rows that are configured to store weight data of a neural network in a single weight data download session, wherein N is a positive integer not smaller than two; and
a first arithmetic logic unit (ALU), configured to receive a first activation input, and perform convolution operations upon the first activation input and a single row of weight data selected from the N rows of the first memory cell array to generate first convolution outputs.

2. The DCIM system of claim 1, wherein during a continuous period in which the single row of weight data is set by a first row of weight data in the first memory cell array, the first ALU is further configured to receive a second activation input after receiving the first activation input, and perform convolution operations upon the second activation input and the first row of weight data in the first memory cell array.

3. The DCIM system of claim 2, further comprising:
a row selection circuit, configured to select the first row of weight data from the first memory cell array to act as the single row of weight data, and further configured to update the single row of weight data by selecting a second row of weight data selected from the first memory cell array when the single row of weight data is currently set by the first row of weight data.

4. The DCIM system of claim 3, wherein the row selection circuit is configured to perform row selection upon the first memory cell array for updating the single row of weight data every T cycles, where T is a positive integer not smaller than two.

5. The DCIM system of claim 4, further comprising:
a pre-processing circuit, configured to receive a source activation input in a first order, and output the source activation input in a second order to generate and output the first activation input to the first DCIM macro, wherein the second order is different from the first order.

6. The DCIM system of claim 5, further comprising:
a post-processing circuit, configured to perform accumulation according to the first convolution outputs to generate accumulation results in the second order, and convert the second order back to the first order for updating convolution results according to the accumulation results.

7. The DCIM system of claim 3, further comprising:
a post-processing circuit, configured to:
accumulate multiple convolution outputs each corresponding to a first input channel number, to generate an accumulation result that corresponds to a second input channel number larger than the first input channel number; or
pack multiple convolution outputs each corresponding to a first output channel number, to generate a packing result that corresponds to a second output channel number larger than the first output channel number.

8. The DCIM system of claim 1, further comprising:
a post-processing circuit, configured to generate accumulation results according to the first convolution outputs; and
a pre-processing circuit, configured to retrieve the accumulation results, and generate and output a second activation input to the first DCIM macro according to the accumulation results.

9. The DCIM system of claim 8, further comprising:
a storage device;
wherein the post-processing circuit is further configured to store the accumulation results into the storage device; and the pre-processing circuit is further configured to retrieve the accumulation results from the storage device.

10. The DCIM system of claim 1, further comprising:
a second DCIM macro, comprising:
a second memory cell array, having N rows that are configured to store weight data of the neural network in a single weight data download session; and
a second ALU, configured to receive a second activation input, and perform convolution operations upon the second activation input and a single row of weight data selected from the N rows of the second memory cell array to generate second convolution outputs;
a pre-processing circuit, configured to generate and output a first source activation input and a second activation input, wherein the first source activation input corresponds to a first part of a plurality of input channels, the second source activation input corresponds to a second part of the plurality of input channels, the first activation input is derived from the first source activation input, and the second activation input is derived from the second source activation input; and
a post-processing circuit, configured to generate accumulation results according to the first convolution outputs and the second convolution outputs.

11. The DCIM system of claim 1, further comprising:
a pre-processing circuit, configured to receive a first source activation input, determine a data access pattern according to a convolution type of the convolution operations, and obtain and output the first activation input from the first source activation input by accessing the first source activation input according to the data access pattern;
wherein different data access patterns are selected for different convolution types.

12. A digital compute-in-memory (DCIM) method comprising:
in a single weight data download session, storing weight data of a neural network into N rows of a first memory cell array included in a first DCIM macro, wherein N is a positive integer not smaller than two; and
performing convolution operations upon a first activation input of the first DCIM macro and a single row of weight data selected from the N rows of the first memory cell array to generate first convolution outputs.

13. The DCIM method of claim 12, further comprising:
during a continuous period in which the single row of weight data is set by a first row of weight data in the first memory cell array, receive a second activation input after receiving the first activation input, and performing convolution operations upon the second activation input and the first row of weight data in the first memory cell array.

14. The DCIM method of claim 13, further comprising:
selecting the first row of weight data from the first memory cell array to act as the single row of weight data; and
updating the single row of weight data by selecting a second row of weight data selected from the first memory cell array when the single row of weight data is currently set by the first row of weight data.

15. The DCIM method of claim 14, further comprising:
performing row selection upon the first memory cell array for updating the single row of weight data every T cycles, where T is a positive integer not smaller than two.

16. The DCIM method of claim 15, further comprising:
receiving a source activation input in a first order; and
outputting the source activation input in a second order to generate and output the first activation input, wherein the second order is different from the first order.

17. The DCIM method of claim 16, further comprising:
performing accumulation according to the first convolution outputs to generate accumulation results in the second order; and
converting the second order back to the first order for updating convolution results according to the accumulation results.

18. The DCIM method of claim 14, further comprising:
accumulating multiple convolution outputs each corresponding to a first input channel number, to generate an accumulation result that corresponds to a second input channel number larger than the first input channel number; or
packing multiple convolution outputs each corresponding to a first output channel number, to generate a packing result that corresponds to a second output channel number larger than the first output channel number.

19. The DCIM method of claim 12, further comprising:
generating accumulation results according to the first convolution outputs; and
generating a second activation input of the first DCIM macro according to the accumulation results.

20. The DCIM method of claim 19, further comprising:
storing the accumulation results into a storage device; and
retrieving the accumulation results from the storage device.

21. The DCIM method of claim 12, further comprising:
in a single weight data download session, storing weight data of the neural network into N rows of a second memory cell array included in a second DCIM macro;
performing convolution operations upon a second activation input of the second DCIM macro and a single row of weight data selected from the second memory cell array to generate second convolution outputs;
generating a first source activation input and a second activation input, wherein the first source activation input corresponds to a first part of a plurality of input channels, the second source activation input corresponds to a second part of the plurality of input channels, the first activation input is derived from the first source activation input, and the second activation input is derived from the second source activation input; and
generating accumulation results according to the first convolution outputs and the second convolution outputs.

22. The DCIM method of claim 12, further comprising:
receiving a first source activation input;
determining a data access pattern according to a convolution type of the convolution operations; and
obtaining and outputting the first activation input of the first DCIM macro from the first source activation input by accessing the first source activation input according to the data access pattern;
wherein different data access patterns are selected for different convolution types.
